(19) United States
(12) Patent Application Publication
(10) Pub. No.: US 2023/0392793 A1
(43) Pub. Date: Dec. 7, 2023

(54) FAUX FIREPLACE WITH USER SELECTABLE VIDEO FILE

(71) Applicant: Modern Flames, LLC, Phoenix, AZ (US)

(72) Inventors: Jim Nolton, Scottsdale, AZ (US); Kris Richardson, Tempe, AZ (US); Harland Aguirre, Glendale, AZ (US); David Faszer, Gilbert, AZ (US)

(21) Appl. No.: 18/233,854

(22) Filed: Aug. 14, 2023

Related U.S. Application Data
(63) Continuation-in-part of application No. 17/968,380, filed on Oct. 18, 2022, now Pat. No. 11,725,791.
Application No. 17/968,380 is a continuation-in-part of application No. 17/666,200, filed on Feb. 7, 2022, now Pat. No. 11,473,745.

(51) Int. Cl. F24C 7/00; H04N 21/472

(52) U.S. Cl. CPC F24C 7/004; H04N 21/47217

(57) ABSTRACT

A faux fireplace including memory having a video file that is selectively provided by a user. The video file includes a video of a faux flame. The video file can be wirelessly uploaded by a user into the memory of the faux fireplace from a wireless device. The video file can be stored on memory selectively removeable and replaceable by a user. The wireless input device can be a remote control and a smart mobile device running an application.

### PRIORITY

This application is a Continuation-in-Part (CIP) of U.S. patent application Ser. No. 17/968,380 filed Oct. 18, 2022, issued as U.S. Pat. No. 11,725,791, entitled Faux Fireplace With Variable Flame Speed, which is a Continuation-in-Part (CIP) of U.S. patent application Ser. No. 17/666,200 issued as U.S. Pat. No. 11,473,745 entitled Faux Fireplace With Synchronized Lighting filed Feb. 11, 2022 and claims priority therefrom.

### TECHNICAL FIELD

The present disclosure relates to faux fireplaces that generate realistic faux flames for homes, apartments, hotels, commercial buildings, and other confined locations.

### BACKGROUND

Faux fireplaces are commonly used in personal homes, condominiums, apartments and the like to generate a faux (synthetic or simulated) flame when a real burning fireplace is not allowable or preferred.

This disclosure includes a faux fireplace designed to eliminate the challenges and disadvantages commonly associated with gas or wood burning fireplaces without compromising the realism of the flames.

### BRIEF DESCRIPTION OF THE FIGURES

FIG. 1A illustrates a perspective front view of the faux fireplace including a video display generating a displayed faux flame along with a separate, lit ember bed, down-lighting and heater;

FIG. 1B illustrates a remote control with control buttons, where some buttons are also provided on the control panel located on the fireplace;

FIGS. 1C-1E illustrates buttons and their function of the remote control and of the control panel;

FIG. 2 illustrates a block diagram of the faux fireplace;

FIG. 3A illustrates a view of smart phone controlled application (App) having a style menu region configured to control the synchronization of the colored lighting;

FIG. 3B illustrates the home screen of the remote control display, including the function and action of each button of the remote control shown in FIG. 3A;

FIG. 4A-4E illustrates the style menu options for selecting multiple styles of faux flames and the color of the faux flames;

FIG. 5A illustrates a color picker menu for selecting the color of the ember bed lighting and FIG. 5B illustrates a color picker menu for selecting the color of the downlight;

FIG. 6 illustrates a heater menu for selecting a heat setting of a heater integrated in the faux fireplace;

FIG. 7 illustrates the timer menu for selecting a time duration for the heater and an auto turn-off feature;

FIG. 8 illustrates a sub-menu enabling the programming schedule for the heater and faux flame;

FIG. 9 illustrates Sunday being selected in the sub-menu of FIG. 8 to establish a programmable schedule for operating the faux flame, the heater and the blower;

FIG. 10 illustrates an example programmed schedule for Sunday corresponding to the sub-menu of FIG. 9;

FIG. 11A and FIG. 11B illustrates a method of operating the faux fireplace; and

FIG. 12 illustrates a method of a user selectively providing a video file stored in memory.

### DETAILED DESCRIPTION

A faux fireplace including memory having a video file that is selectively provided by a user. The video file includes a video of a faux flame. The video file can be wirelessly uploaded by a user into the memory of the faux fireplace from a wireless device. The video file can be stored on memory selectively removeable and replaceable by a user. The wireless input device can be a remote control and a smart mobile device running an application.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and circuitry have been described at a relatively high-level, without detail, in order to avoid unnecessarily obscuring aspects of the present teachings.

The term “coupled” as used herein refers to any logical, optical, physical or electrical connection, link or the like by which signals, or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

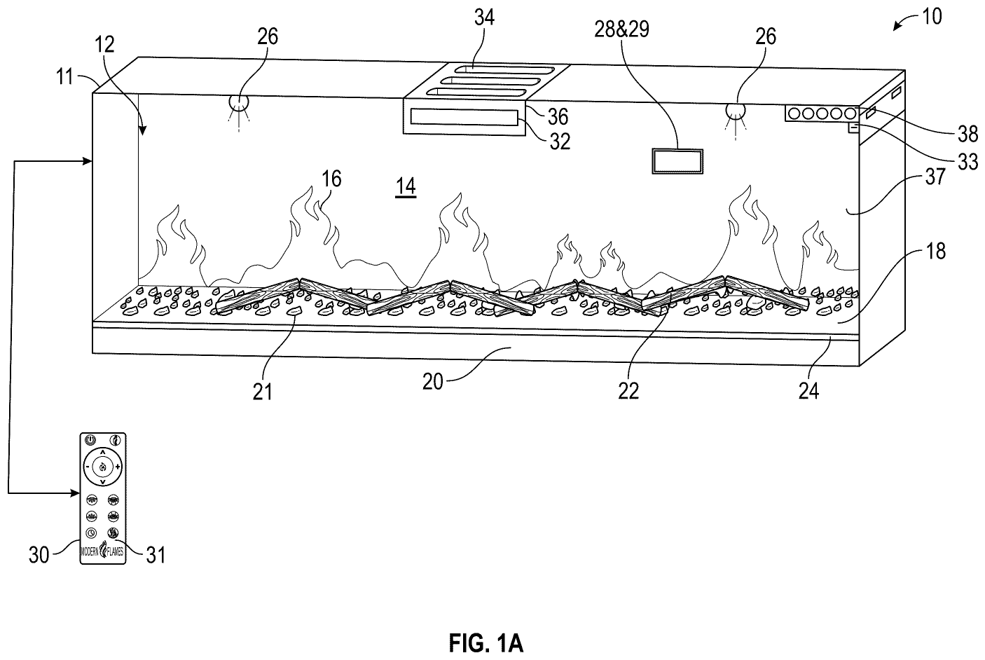

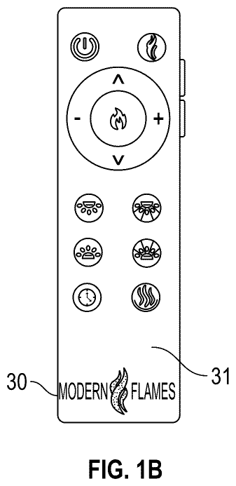

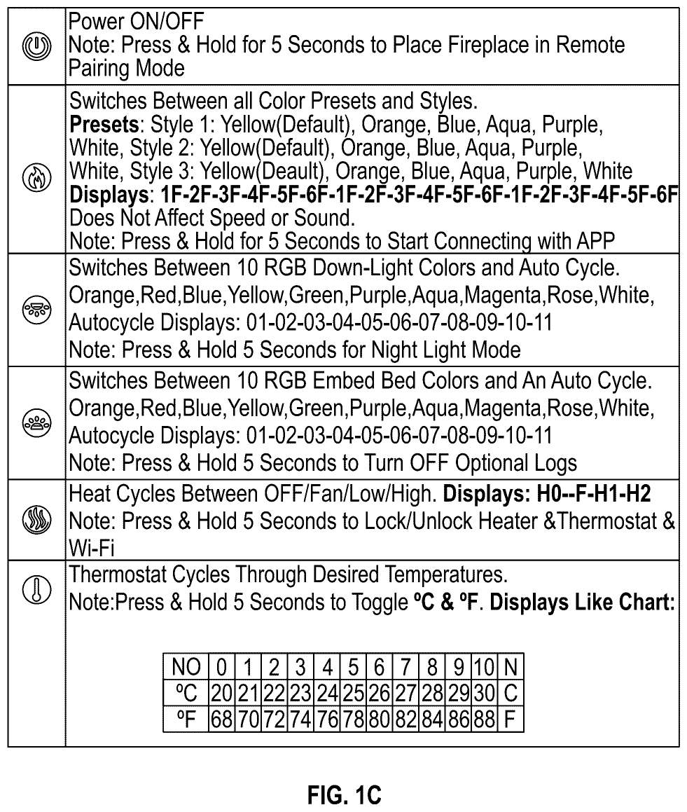

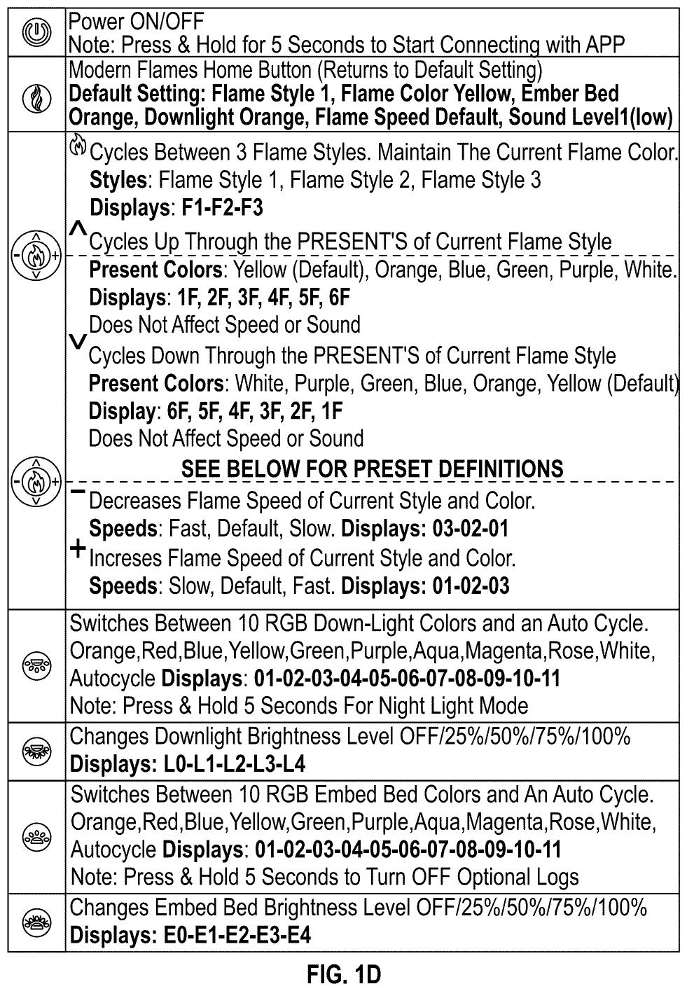

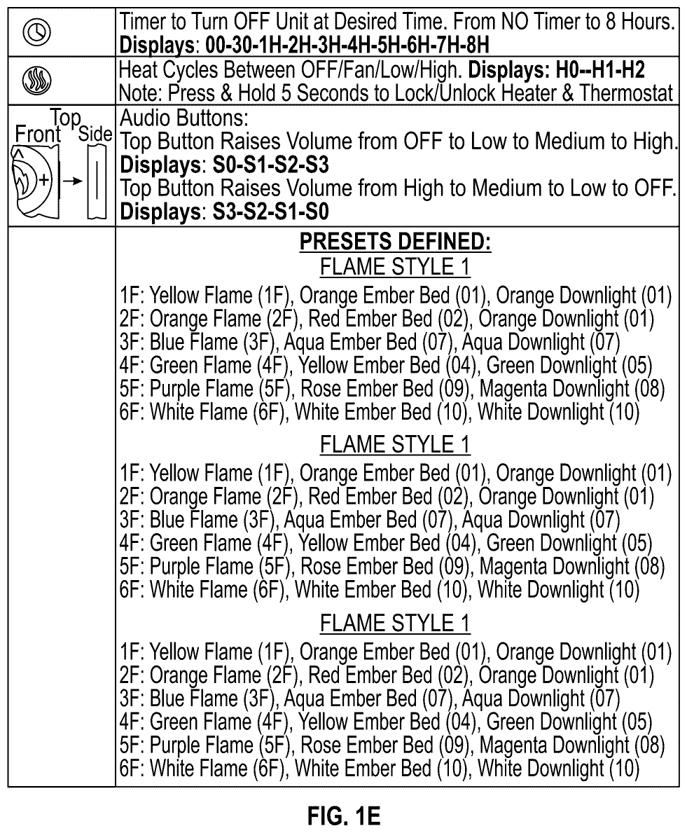

Referring to FIG. 1A there is illustrated a faux fireplace 10 having a body 11 including a cavity 12, shown as a chassis having a firebox including a vertically extending electronic video display 14 configured to display a looping video of a faux flame shown at 16. The video display 14 may be formed by one or more panels to display a larger and horizontal faux flame 16. The faux fireplace 10 is configured as an insert that can slide directly into an opening in a wall, such as between studs and surrounded by drywall or other material. Faux fireplace 10 has a rather shallow depth, such as 6 inches, and includes a faux ember bed 18 at the firebox bottom 20 extending forwardly from the video display 14. Ember bed 18 is covered by a media 21, such as glacier crystals or crushed glass, and includes a plurality of resin faux logs 22 positioned on the ember bed 18. Ember bed lighting 24 is positioned under the ember bed 18 and is configured to selectively illuminate the ember bed 18 and media 21 with a selectable color. Down-lighting 26 at the top of the firebox 12 is configured to selectively illuminate the firebox 12 and faux logs 22 from above at a user selectable color.

The ember bed lighting 24 and the down-lighting 26 may be created by a light emitting diode (LED), or the like. The lighting may be comprised of red/green/blue (RGB) lighting. Firebox 12 includes at least one heater 32 configured to generate radiant heat, and vents 34 configured to emit the generated heat using a blower 36.

The ember bed 18 may be formed of a plastic (e.g., Polystyrene or Acrylic) ember bed screen (white color) acting as a diffusion material for the underlaying ember bed lighting 24. The media 21, such as glacier crystals or crushed glass, are laid on top of the ember bed screen to emulate a glowing ember bed of an actual fireplace. The ember bed lighting 24 is positioned uniformly as to not create bright and dim spots on the ember bed screen. Firebox 12 may have a colored glass viewing window 37, such as a tea color, such as tempered glass with sanded edges.

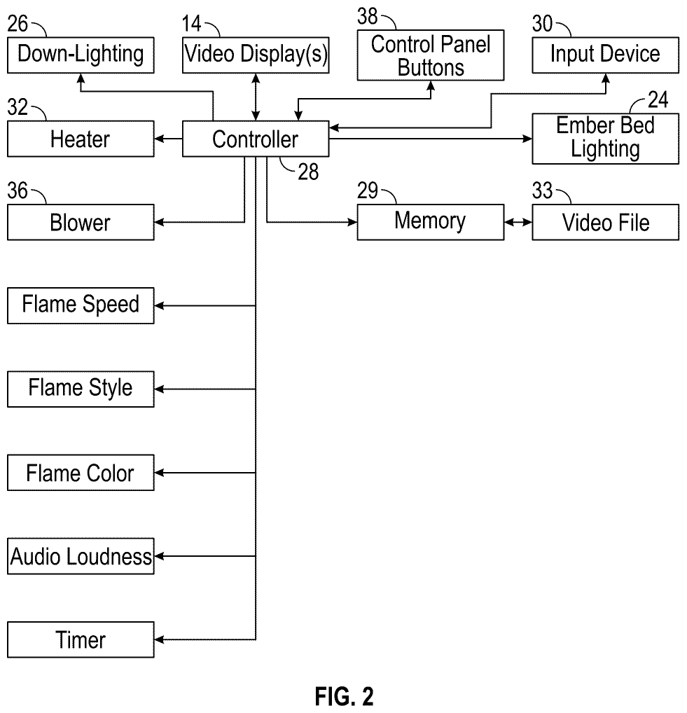

The color of the faux flame 16, the ember bed lighting 24 and the down-lighting 26 is selectively controlled by a controller 28 shown in FIG. 2, such as a processor. The controller 28 is controllable by a user using a control panel 38 having buttons located on an upper right corner of the firebox 12 as shown in FIG. 1A, and wirelessly by using a wireless input device 30 having a user interface 31 via WiFi and BlueTooth, such as using a remote control as shown in FIG. 1B and a mobile device including a smartphone or computer. A video file 33 including a looping video of the faux flame 16 is stored in memory 29. Controller 28 controls the display of the looping video of the faux flame 16 on video display 14, including a selectable speed of the displayed looping video. In the example shown in FIG. 1A and FIG. 1B, the control panel 38 and the user interface 31 of the wireless input device 30 have pressable or tappable buttons, wherein each button is shown in the left column of FIG. 1C, FIG. 1D, and FIG. 1E with their assigned functions shown in the right column.

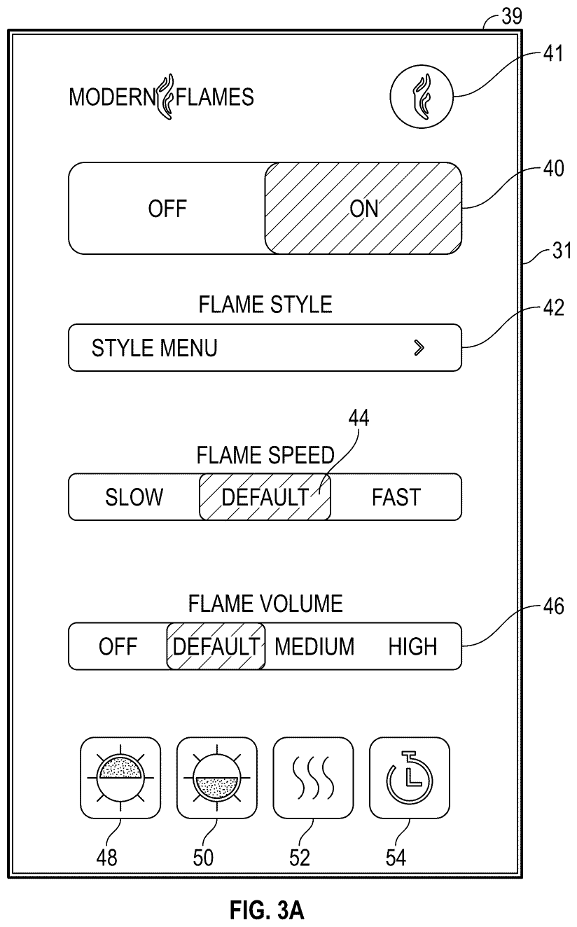

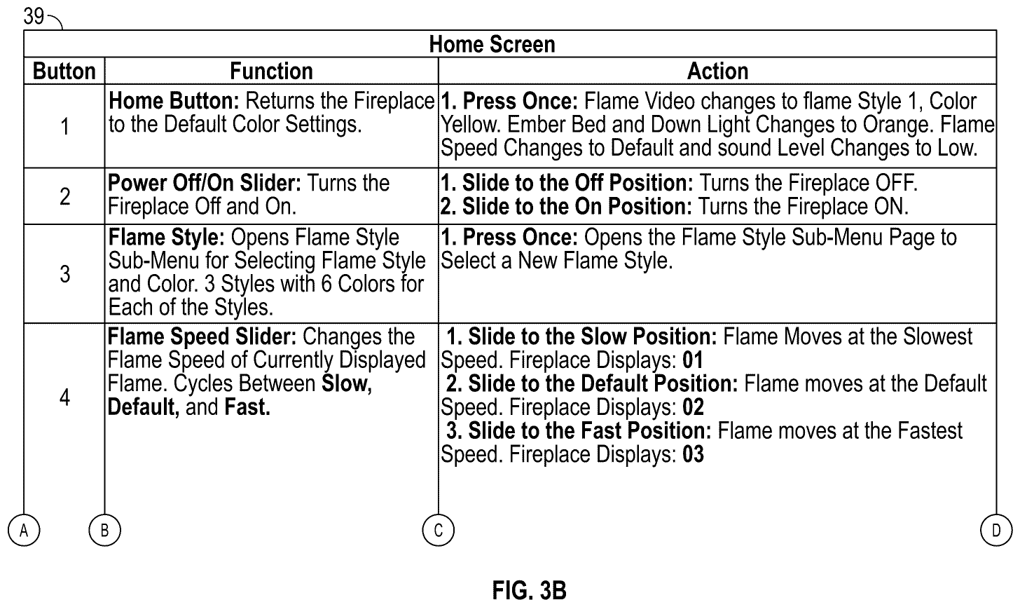

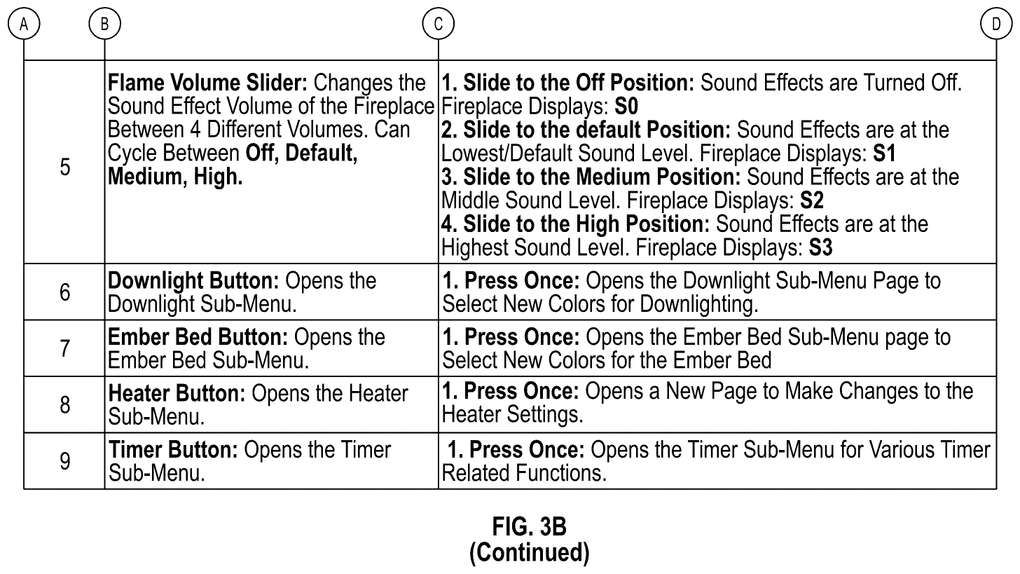

In an example, the wireless input control 30 is a wireless smart mobile device with the user interface 31 including a touch display controlled by an application (app) stored in memory 29, as shown in FIG. 3A. A home screen 39 that is displayed on the touch display 31 of the smart mobile device is shown in FIG. 3B that details the function and action of each button shown in FIG. 3A. The wireless smart mobile device can be a smart phone, as well as a smart watch, smart eyewear, a laptop computer, and other such smart devices. Smart mobile devices control the controller 28 using standard communication protocols, such as Bluetooth, but can also communicate via a wireless network including the internet. The electrical circuitry shown in FIG. 2 includes the memory 29 having the video file(s) 33 for generating the looping video of the faux flame 16, which memory 29 may be part of the controller 28 configured as a system on a chip (SOC), and the memory 29 may be selectively removable and replaceable such as a thumb drive.

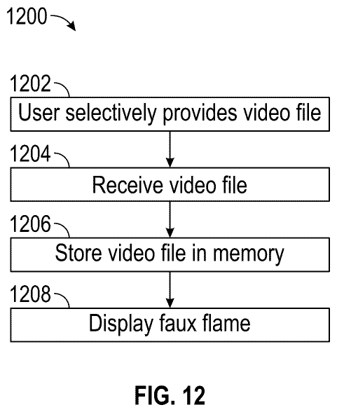

Video file(s) 33 is selectively provided to memory 29 by a user such that a user can control the displayed faux flame via controller 28, such as by providing removable memory 29 and by using a wireless input control 30 such that a user can select and upload video files 33 with a desired faux flame 16. In an example, wireless input control 30 can present a library of video files 33 to a user for selection, such as thumbnails. Wireless input control 30 can also display a video of the video files 33 on display 31 to allow the user to preview the video files 33. The user can select and wirelessly upload one or more desired video files 33 to memory 29 using wireless input control 30. In an example, the video files 33 can have different flame patterns with different flicker characteristics, different colors, different flame speeds, different sizes and so forth. This method is described further with reference to FIG. 12. The video files 33 can also be uploaded to the faux fireplace 10 by a manufacturer as part of a software update.

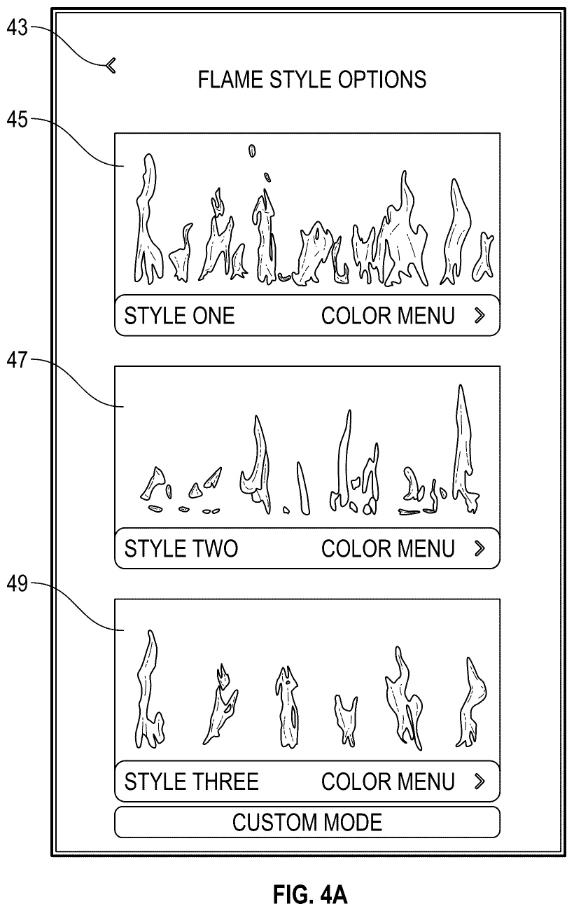

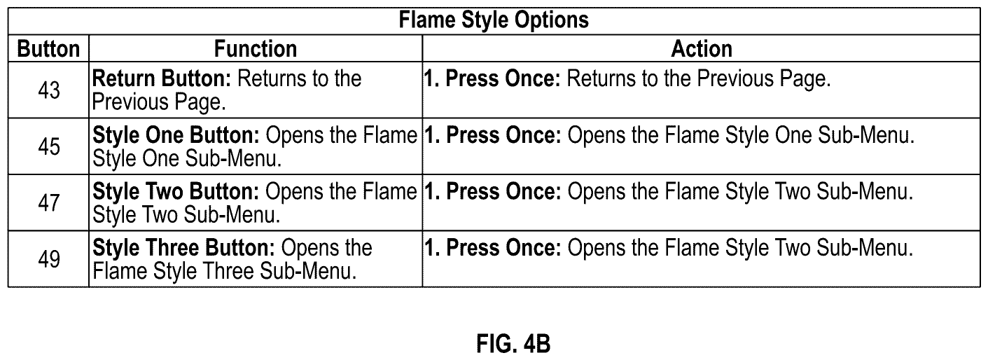

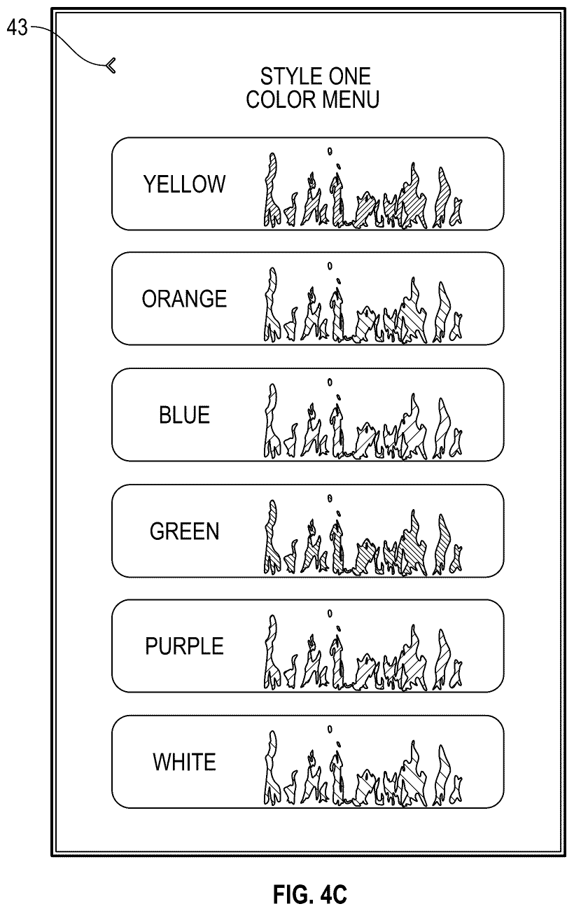

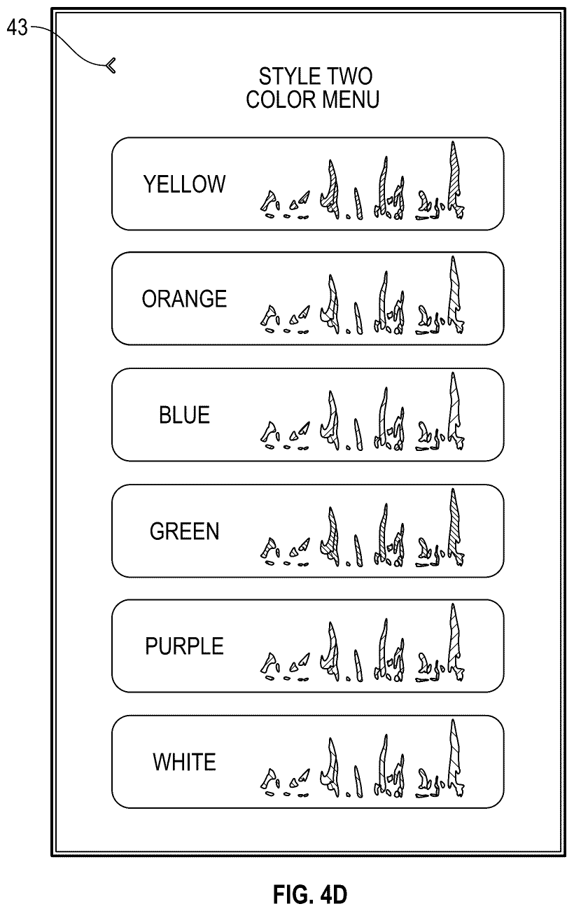

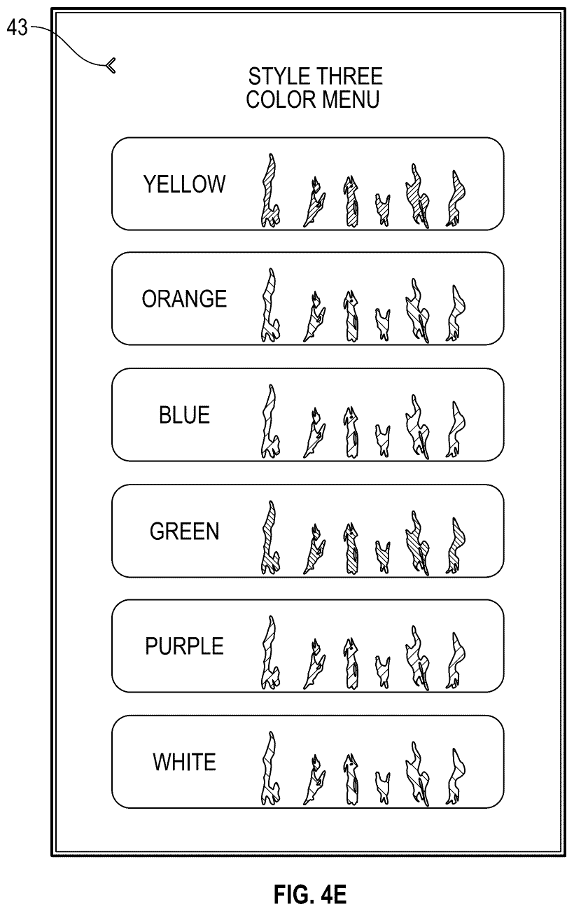

Referring to FIG. 3A, there is illustrated wireless input device 30 shown as a remote control having touch display 31 operating based on a smart phone application stored in memory 29. FIG. 3B illustrates the home screen of display 31, including the function and action of each displayed button of the remote control 30 shown in FIG. 3A. Display 31 displays a home button 41 and a power on/off slider button at 40. A flame style option button 42 opens a flame sub-menu shown in FIG. 4A for selecting the flame style and color, wherein settings of the flame style and color are selected using displayed buttons 43, 45, 47 and 49 having the functions and actions shown in FIG. 4B. Three flame style settings with six colors for each of the styles are shown in FIG. 4C-4E. Tapping the respective displayed flame color shown in FIG. 4C-4F selects the color of the displayed faux flame 16.

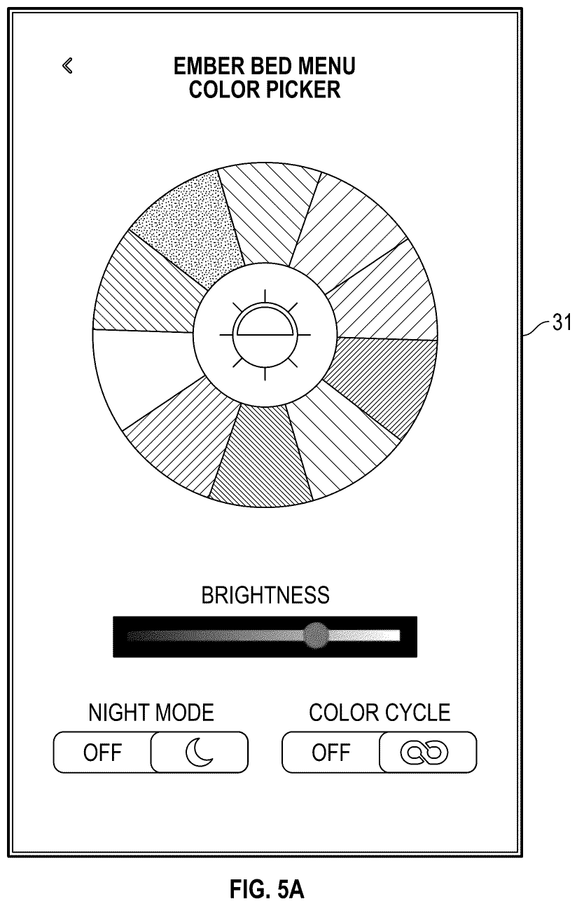

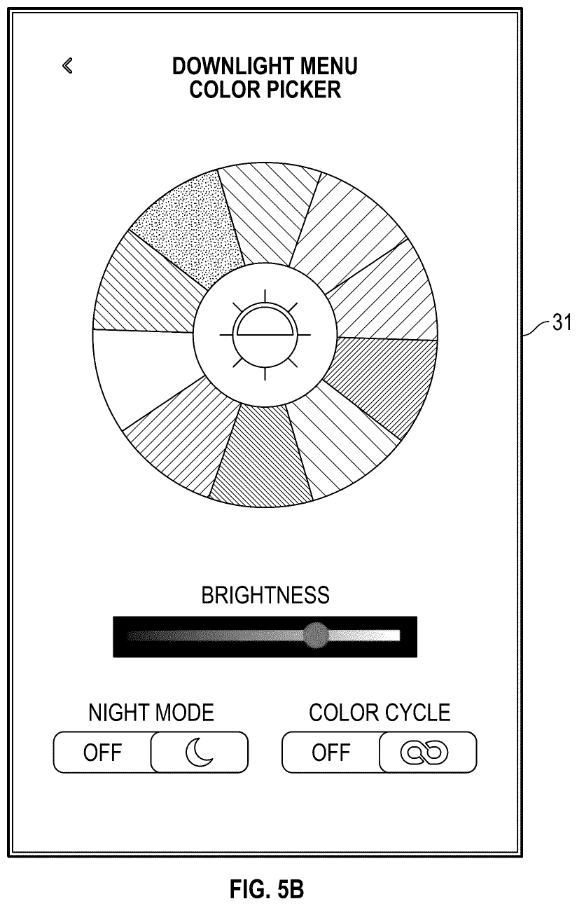

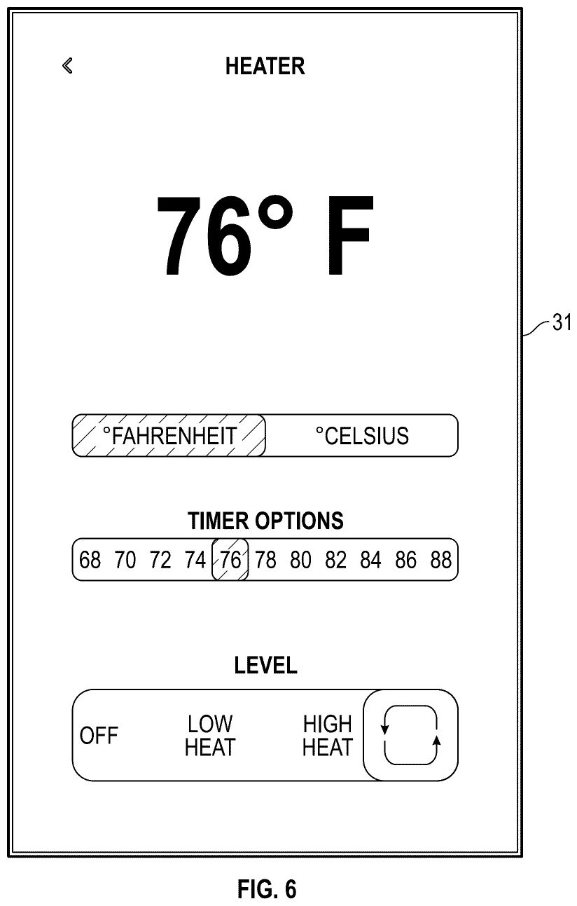

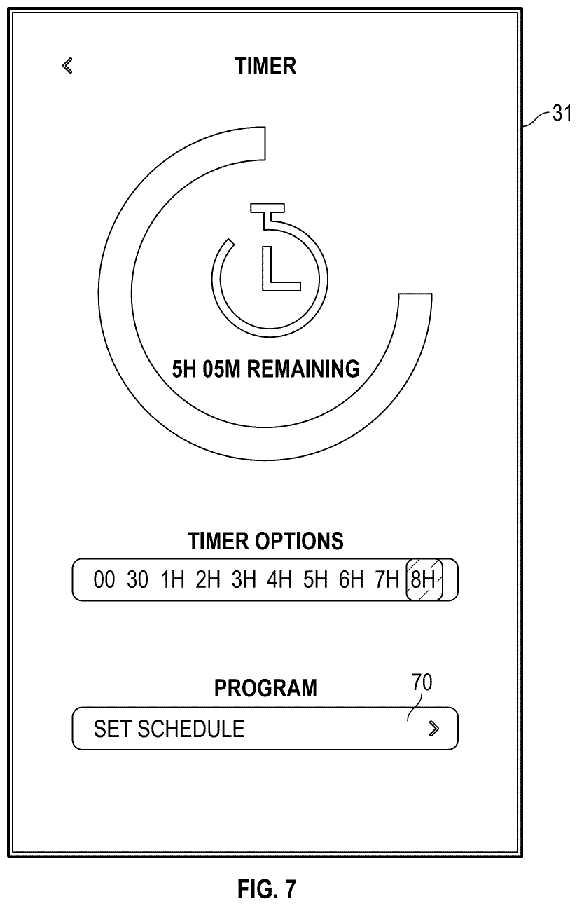

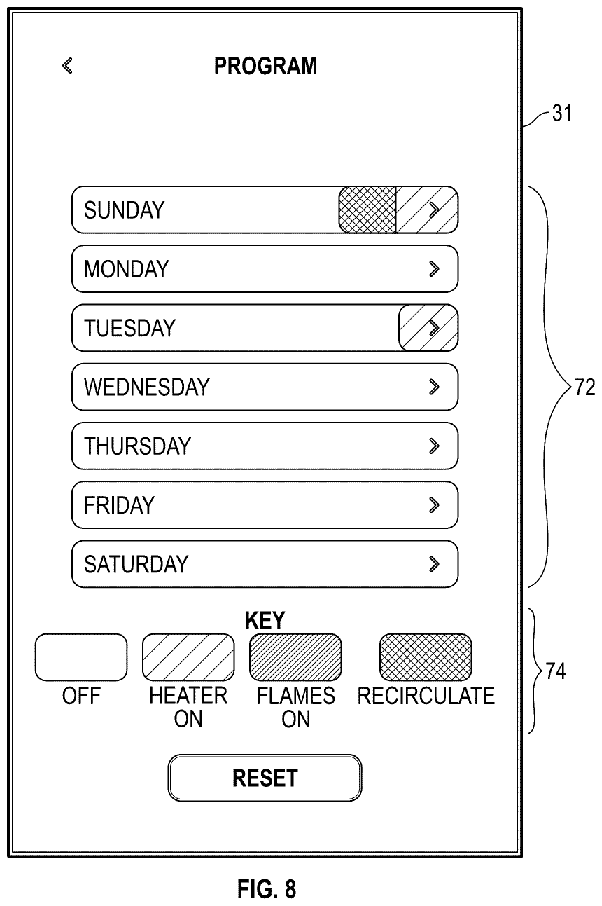

A flame speed slider button 44 allows the user to change the flame speed of the displayed faux flame 16 between three settings of current flame displayed, shown as slow, default and fast. The flame speed slider button 44 controls the playback speed of the video loop displayed on display 14 to give the user control of the flame and a rate of a flame flicker. A volume control slider button 46 allows the user to change a sound effect and volume, such as a flame crackling sound, displayed as having a selection of off, default, medium and high. A down-lighting control button has an icon shown at 48 which opens a down-light sub-menu shown in FIG. 5A to allow the user to select the color and brightness of the down-lighting 26. An ember bed control button has an icon shown at 50 and opens up the same sub-menu shown in FIG. 5B to allow the user to select the color and brightness of the ember bed lighting 24. A heater button has an icon shown at 52 that opens a sub-menu shown in FIG. 6 for controlling the heat generated by the heater 32. A timer button has an icon shown at 54 that opens a sub-menu shown in FIG. 7 for controlling the time duration for operating the auto shut off feature of the faux fireplace 10. The sub-menu includes a set schedule button 70 that opens a weekly programming sub-menu shown in FIG. 8 that has individual seven-day options shown at 72. If a program is set by the user for that day, the color tab is displayed on the end of that day. Color keys 74 enable the user to control heater 32, the faux flame 16, and air recirculation using fan 36. The reset button allows the user to reset all seven days of any programming.

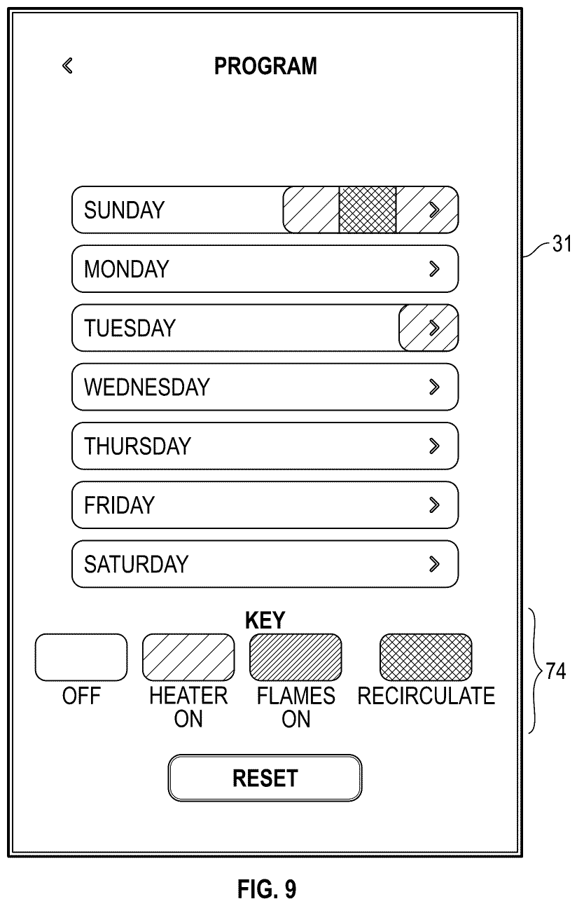

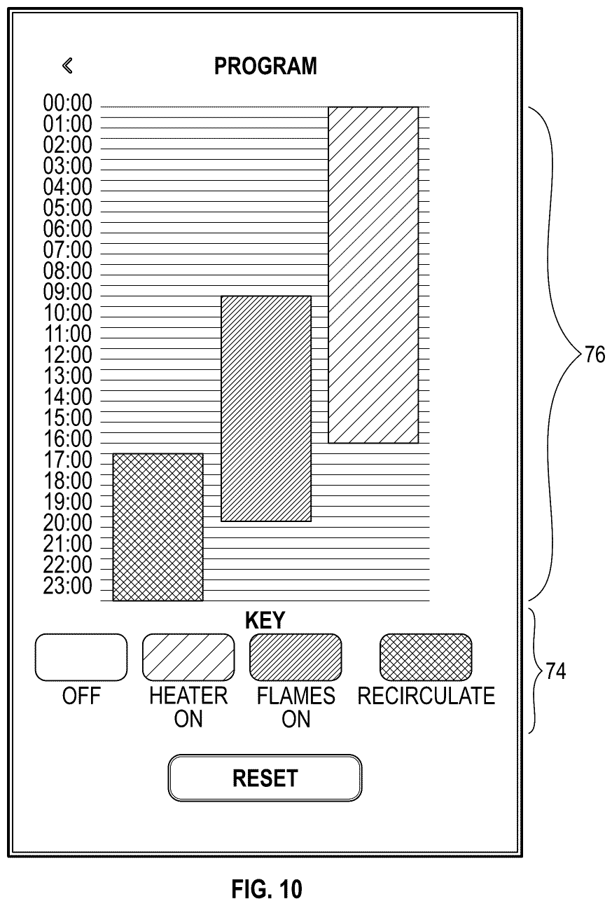

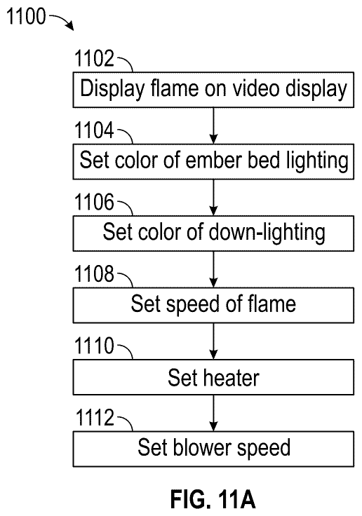

FIG. 9 illustrates the individual day programming button for Sunday selected, which upon selection by the user opens the sub-menu illustrated in FIG. 10. After the user selects an option on key 74, a schedule 76 for Sunday can be programmed using remote control 30 by selecting the time of day for each option by swiping a finger over the decided time duration. In an example, FIG. 10 illustrates the heater 32 being on from 17:00 to 24:00, the faux flame 16 being on from 09:30 to 19:30, and the blower 38 being on from 00:00 to 16:00.

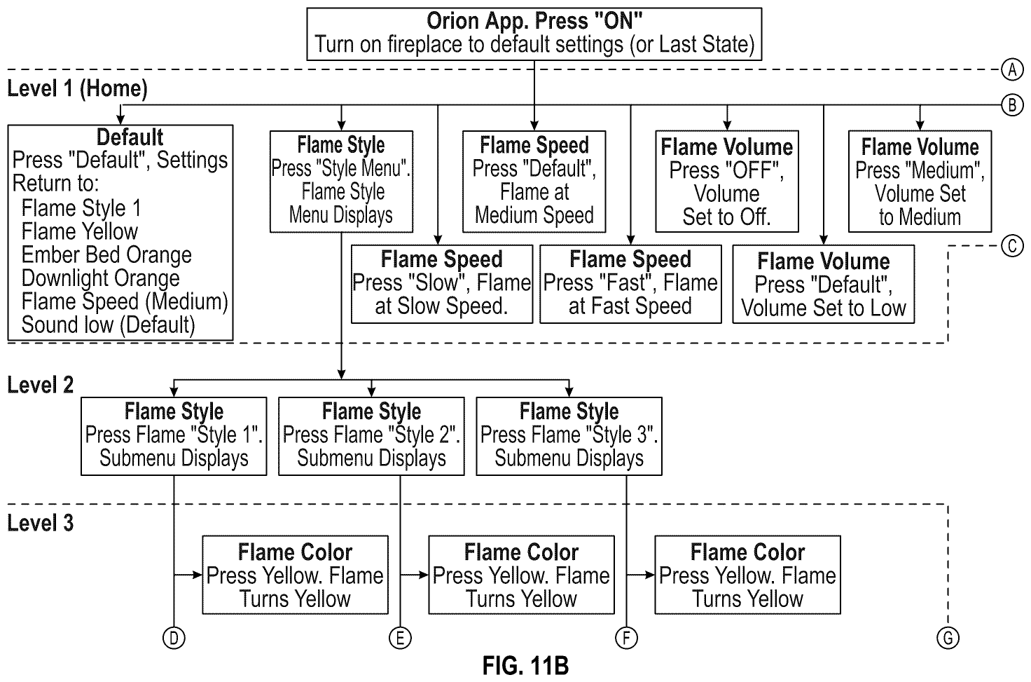

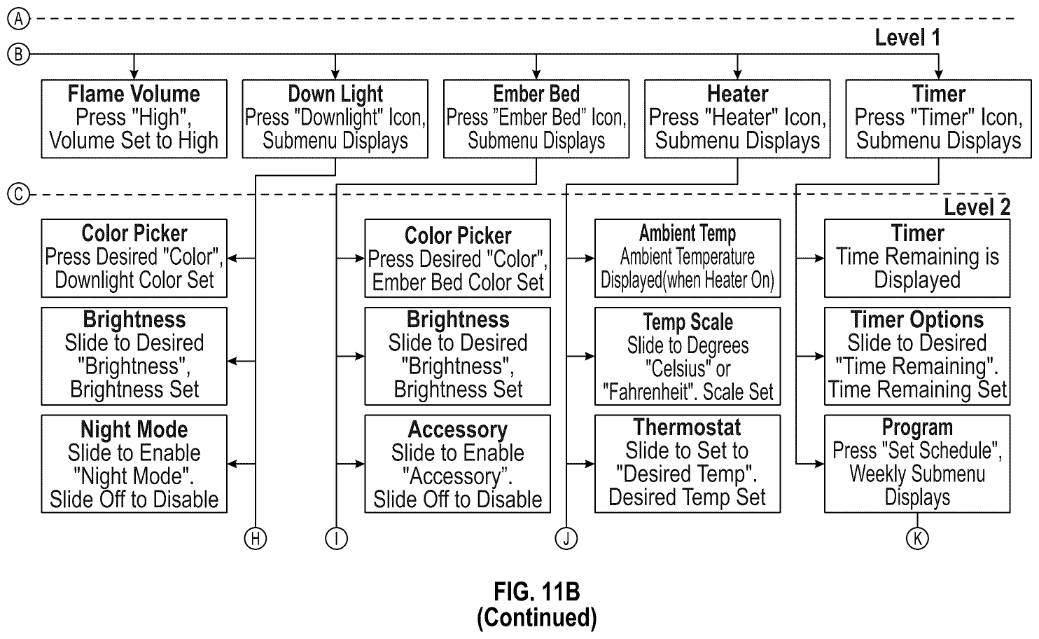

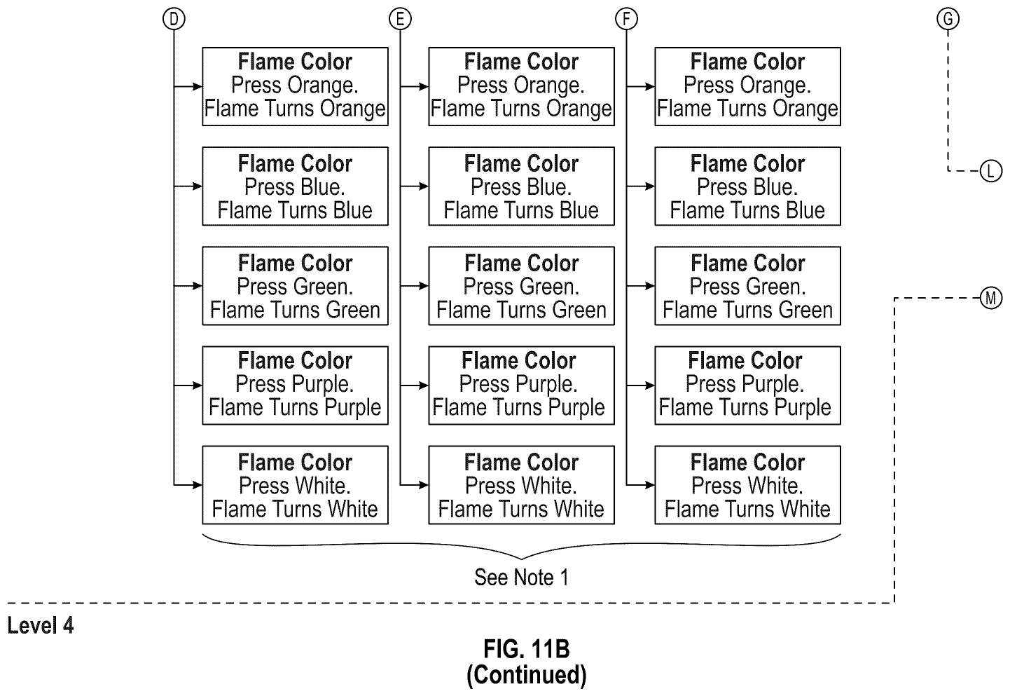

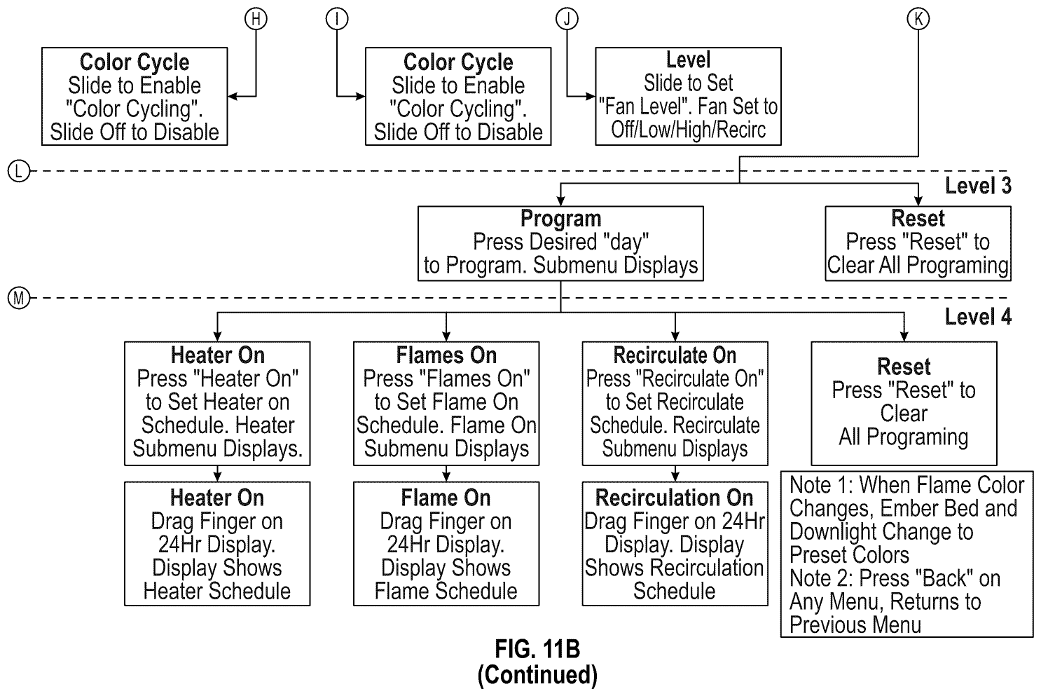

Referring to FIGS. 11A-11B, there is shown method 1100 for operating the faux fireplace 10. The faux fireplace 10 can be manually controlled by the control panel 38, by the remote control 30 using the smart phone app, or automatically by the program schedule 76 of the smart phone app, executed by controller 28 as discussed.

At block 1102, the display 14 is selected to be on to generate the faux flame 16, using a button of the control panel 38, the remote control 30 as illustrated in FIG. 1B, or the remote control 30 including a smart mobile device having the smart phone app as shown in FIG. 3A. The color of the displayed faux flame 16 and the flame style is a button of the control panel 38, the remote control 30 as illustrated in FIG. 1B, or the remote control 30 including a smart mobile device having the smart phone app as shown in FIG. 3A.

At block 1104, the color of the ember bed lighting 24 is established using a button of the control panel 38, the remote control 30 as illustrated in FIG. 1B, or the remote control 30 including a smart mobile device having the smart phone app as shown in FIG. 3A.

At block 1106, the color of the down-lighting 26 is established a button of the control panel 38, the remote control 30 as illustrated in FIG. 1B, or the remote control 30 including a smart mobile device having the smart phone app as shown in FIG. 3A.

At block 1108, the speed of the faux flame 16 as displayed on the video display 14 is established using a button of the control panel 38, the remote control 30 as illustrated in FIG. 1B, or the remote control 30 including a smart mobile device having the smart phone app as shown in FIG. 3A. The faux flame speed selection allows the user to change the playback speed of the video loop of the displayed faux flame 16 between three settings of the current flame displayed, shown as slow, default and fast. The selected speed of the faux flame 16 is established by the controller 28 controlling the playback speed of the video loop stored in memory 29. This feature allows the user to control the speed of the faux flame 16 presentation, including a flicker rate of the faux flame 16, and establish an ambiance for the user.

At block 1110, the heater 32 is controlled using a button of the control panel 38, the remote control 30 as illustrated in FIG. 1B, or the remote control 30 including a smart mobile device having the smart phone app as shown in FIG. 3A.

At block 1112, the blower 36 is controlled by using a button of the control panel 38, the remote control 30 as illustrated in FIG. 1B, or the remote control 30 including a smart mobile device having the smart phone app as shown in FIG. 3A.

FIG. 12 illustrates method 1200 for selecting and uploading different video files 33 to memory 29 using wireless input device 30.

At block 1202, a user of wireless input device 30 selects one or more video files 33 from a library of video files, such as displayed on display 31. The library of video files can be preloaded on wireless input device 30, and may be downloadable from a remote server, such as a server hosted by a manufacturer. The manufacturer of faux fireplace 10 can continuously update the library of video files on the server to provide product support to the customer over the lifetime of faux fireplace 10.

At block 1204, controller 28 receives the wirelessly uploaded video files 33 from wireless input device 30. The uploaded files 33 can be transmitted using a wireless interface, such as using BlueTooth and WiFi.

At block 1206, the uploaded video files 33 are stored in memory 29. The user can manage the video files 33 stored in memory 29 using wireless input device 30, such as to delete undesired video files 33.

At block 1208, faux fireplace 10 displays faux flame 16 using the uploaded video files 33. The user can select one of several uploaded video files 33 to display during use, in real time, and also by using the schedule as described using wireless input control 30. In an example, a different video file 33 can be programmed by a user to executed and displayed at different times and dates as desired.

The appended claims set forth novel and inventive aspects of the subject matter described above, but the claims may also encompass additional subject matter not specifically recited in detail. For example, certain features, elements, or aspects may be omitted from the claims if not necessary to distinguish the novel and inventive features from what is already known to a person having ordinary skill in the art. Features, elements, and aspects described herein may also be combined or replaced by alternative features serving the same, equivalent, or similar purpose without departing from the scope of the invention defined by the appended claims.

What is claimed is:

1. A faux fireplace, comprising:
a body;
a display coupled to the body and configured to display a faux flame;
a controller responsive to a control input and configured to selectively control the displayed faux flame; and
a memory coupled to the controller and including a video file of the faux flame, wherein the controller is configured to display the faux flame based on the video file, wherein the video file is configured to be selectively provided by a user such that a user can control the displayed faux flame.

2. The faux fireplace as specified in claim 1, wherein the video file is configured to be wirelessly uploaded into the memory from a remote device.

3. The faux fireplace as specified in claim 1, wherein the memory is removable from the body.

4. The faux fireplace as specified in claim 1, wherein the video file is a video of a faux flame.

5. The faux fireplace as specified in claim 4, wherein the controller is configured to control a playback speed of the video.

6. The faux fireplace as specified in claim 5, wherein the playback speed is configured to establish a flicker rate of the displayed faux flame.

7. The faux fireplace as specified in claim 1, wherein the control input is a wireless remote control.

8. The faux fireplace as specified in claim 1, wherein the faux fireplace further includes a heater configured to generate heat, and a blower configured to blow the generated heat.

9. The faux fireplace as specified in claim 8, wherein the controller is configured to use a schedule configured to control the displayed faux flame, the heater, and the blower.

10. The faux fireplace as specified in claim 9, wherein the schedule is configured to control when the faux flame is displayed, when the heater is on, and when the blower is on.

11. A method of controlling a faux fireplace, comprising a body, a display coupled to the body and configured to display a faux flame, a controller responsive to a control input and configured to selectively control the displayed faux flame, and a memory coupled to the controller and including a video file of the faux flame, wherein the controller is configured to display the faux flame based on the video file, wherein the video file is configured to be selectively provided by a user such that a user can control the displayed faux flame, the method comprising:
the controller processing the video file selected by the user; and
the controller controlling the displayed faux flame based on the selected video file such that a user can establish the displayed faux flame.

12. The method as specified in claim 11, wherein the video file is wirelessly uploaded into the memory from a remote device.

13. The method as specified in claim 11, wherein the memory is removable from the body.

14. The method as specified in claim 11, wherein the video file is a video of a faux flame.

15. The method as specified in claim 14, wherein the controller controls a playback speed of the video.

16. The method as specified in claim 15, wherein the playback speed establishes a flicker rate of the displayed faux flame.

17. The method as specified in claim 11, wherein the control input is a wireless remote control.

18. The method as specified in claim 11, wherein the faux fireplace further includes a heater generating heat, and a blower blowing the generated heat.

19. The method as specified in claim 18, wherein the controller uses a schedule to control the displayed faux flame, the heater, and the blower.

20. The method as specified in claim 19, wherein the schedule controls when the faux flame is displayed, when the heater is on, and when the blower is on.
